(19) United States
(12) Patent Application Publication
(10) Pub. No.: US 2013/0181177 A1
(43) Pub. Date: Jul. 18, 2013

(54) LIFTING DEVICE WITH A TOOTHED BELT AS SUPPORTING MEANS

(71) Applicant: Oliver Moll, Solingen (DE)

(72) Inventor: Oliver Moll, Solingen (DE)

(73) Assignee: DEMAG CRANES & COMPONENTS GMBH, Wetter (DE)

(21) Appl. No.: 13/825,751

(22) PCT Filed: Oct. 4, 2011
(86) PCT No.: PCT/EP11/67335

§ 371 Date: Mar. 22, 2013

(30) Foreign Application Priority Data
Oct. 6, 2010 (DE) 10 2010 047 704.4

(51) Int. Cl. B66D 1/28; B66D 1/36; B66D 1/30

(52) U.S. Cl. CPC B66D 1/28; B66D 1/30; B66D 1/36
USPC 254/338

(57) ABSTRACT

The invention relates to a lifting device for lifting and lowering loads with a toothed belt which is driven by an output gear and which is positively engaged with the output gear in a wrapping region. In order to provide an improved lifting device, multiple guiding rollers are fixed to the lifting device in the wrapping region such that said rollers maintain the positive engagement between the toothed belt and the output gear.

### CROSS REFERENCE TO RELATED APPLICATION

The present application claims the priority benefits of International Patent Application No. PCT/EP2011/067335, filed on Oct. 4, 2011, which is hereby incorporated herein by reference in its entirety.

### BACKGROUND OF THE INVENTION

The invention relates to a lifting device, or hoist, for lifting and lowering loads and, in particular, to such lifting device having a toothed belt driven by an output wheel.

German patent specification DE 103 35 984 B4 discloses chain hoists for lifting and lowering loads. Essentially, corresponding chain hoists comprise a motorized drive unit, a gear system, an output shaft—on which a chain wheel is rotatably mounted—and a supporting means in the form of a chain for the indirect reception of the load to be moved. The chain wheel and the chain are positively engaged with each other. Owing to the positive connection, a lifting force, which results from the drive-side torque and the torque transferred by the gear system, is fed into the chain. At its end on the load-side, as seen from the chain wheel, the chain is connected to a freely suspended load-connecting device, such as a load hook. The other, unloaded, chain end is in a container-shaped chain store which receives or releases the chain via an opening depending upon the direction of rotation of the chain wheel. Moreover, a guide can be provided in the region of the chain wheel in order to prevent the chain or individual chain links from getting hooked up or jammed between the chain wheel and the chain store. It is also typical to lubricate the chain over its entire length to reduce wear.

Use of a belt-like supporting and driving means for elevator systems is known from German laid-open document DE 10 2004 047 158 A1. Corresponding elevator systems include an elevator cabin which is guided and moved substantially in a straight line in the vertical direction in an elevator shaft. The supporting and driving means used for this purpose is fastened in a positionally-fixed manner at one end to the base of the elevator shaft and at another end to a ceiling of the elevator shaft and is guided between the two ends via rotatably mounted deflecting disks and a drive disk. In the embodiments described therein, some or all disks can be attached to the elevator cabin which means that they are also moved in a straight line in the vertical direction. The remaining disks are fastened in the elevator shaft in a positionally-fixed manner. The supporting and driving means is formed in the manner of a toothed belt or serpentine belt whose teeth or ribs are in contact with the rotating surfaces of the disks.

Japanese laid-open document JP 2005 022 791 A discloses a four-cable lifting device whose four supporting means provided for lifting and lowering loads are formed as toothed belts. The toothed belts are each attached at a first end to a drum winch and are wound on or off therefrom. This drum winch with its own drive only has the task of storing the toothed belt. Starting from the drum winch, the toothed belt is guided in each case via a toothed belt disk vertically downwards in the direction of the load to be lifted. The toothed belt disks, four in total, are driven in a synchronous manner by a common drive and direct the lifting and cable forces into the toothed belt.

German laid-open document DE 39 11 292 A1 relates to a lifting device for lifting and lowering loads, whose supporting means and the output wheel driving the supporting means are replaceable. For example, the supporting means can be formed as a chain, flat cable, round cable or as a toothed belt and in a corresponding manner the output wheel can be formed as a chain wheel, cable disk or toothed belt roller, thus selectively producing a chain hoist, cable hoist or lifting device. For the design as a chain hoist, an insert serving as a supporting means guide is also provided. The insert is disposed above the chain wheel such that the chain is prevented from being pushed out of the chain wheel by the insert.

German laid-open document DE 196 13 037 A1 describes a two-cable stage winch having two supporting means formed as toothed belts. Each toothed belt is driven in a positive-locking and synchronous manner by an output wheel—the output wheels being separate but drivingly connected together—and is wound or unwound from a winding device in each case. Starting from the winding devices disposed above the output wheels, each toothed belt is deflected via a first deflecting roller designated as a pressure roller and is supplied to the corresponding output wheel in the upper region thereof. In order for the toothed belts to positively wrap around from the upper supply point from the output wheels approximately over half their periphery, a lower, second deflecting roller is disposed on each output wheel opposite the upper, first deflecting roller. The lower, second pressure rollers also ensure that the toothed belts run off from or run onto the output wheels in the vertical direction.

German patent specification DE 37 28 494 C1 discloses a cable hoist machine, having a driven cable disk, used in the building industry and in forestry and as a recovery hoist. The cable disk comprises a cable groove in which a cable is guided via a cable pressure roller and slide pieces.

JP H03 9392 U discloses a three-cable cable hoist having three single-grooved cable drums, from each of which a cable is unwound or wound. Each cable is guided in the region of the cable run-in/run-out by four guide rollers in relation to the respective cable groove of the cable drum.

### SUMMARY OF THE INVENTION

The present invention provides an improved lifting device. A lifting device for lifting and lowering loads, according to an aspect of the invention, includes a toothed belt driven by an output wheel and positively engaged with the output wheel in a wrap-around region. At least three guide rollers are disposed one behind the other as seen in the peripheral direction of the output wheel in the wrap-around region. The guide rollers press the toothed belt against the output wheel in the wrap-around region and thus maintain the positive connection between the toothed belt and the output wheel.

In accordance with an embodiment of the invention, an improved lifting device for lifting and lowering loads having a toothed belt driven by an output wheel and positively engaged with the output wheel in a wrap-around region is achieved by virtue of the fact that in the wrap-around region at least three, and perhaps including five to seven, guide rollers are disposed one behind the other as seen in the peripheral direction of the output wheel, which guide rollers press the toothed belt against the output wheel in the wrap-around region and thus maintain the positive connection between the toothed belt and the output wheel. The positive-connection between the toothed belt and the output wheel is ensured thus avoiding the risk of the load falling. By ensuring the positive connection by means of corresponding guide rollers, secure lifting and lowering of heavy loads using a lifting device is also made possible. In particular, a uniform positive connection over the entire wrap-around region is achieved by a corresponding arrangement of guide rollers.

In a constructionally simple design, provision is made that two adjacent guide rollers are spaced apart from each other at most over 30° of the wrap-around region as seen in the peripheral direction of the output wheel.

The safety of the lifting device may be increased by virtue of a wrap-around region that is at least 90°. The wrap-around region may be 120° to 150°, and even 120° to 180°.

A secure toothed belt guidance over the output wheel may be further improved by virtue of the toothed belt being supplied to and from the output wheel via—in addition to guide rollers—additional deflecting rollers or idler rollers.

For secure rigging of loads to be lifted, a load-connecting device may be suspended on the toothed belt. The load-connecting device may be freely suspended to permit flexible rigging of loads to be lifted. The load-connecting device may be suspended on a first end of the toothed belt in a constructionally simple design. The load-connecting device may be formed as a lower block in a singly reeved embodiment.

The output wheel may be located on an output shaft in a rotationally-fixed manner and the output shaft drivingly connected to an electric motor via a gear system.

The risk of canting or jamming can be minimized by the use of a belt store which stores the toothed belt and is fastened to the lifting device.

The belt store may include a storage roller rotatably mounted on a shaft to which the toothed belt is connected at its second end and on which the toothed belt can be wound. This increases reliable operation of the lifting device by ordered storage of the toothed belt on the storage roller. Winding of the toothed belt can be improved by the storage roller being connected to the shaft via a torsion spring. Starting from a wound toothed belt, unwinding of the toothed belt tensions the torsion spring and the toothed belt can be wound on the storage roller via the force resulting from the energy stored in the tensioned torsion spring. The process of winding the toothed belt may include the storage roller being drivingly connected to an electric winding motor.

Increased and stable running smoothness of the toothed belt during operation of the lifting device can be effected with at least one deflecting roller that guides the toothed belt starting from the belt store to the output wheel and at least two idler rollers carry the toothed belt away from the output wheel. The deflecting roller and the idler rollers may be fastened to a housing of the lifting device.

### BRIEF DESCRIPTION OF THE DRAWINGS

An exemplified embodiment of the invention will be explained in more detail with the aid of the following description in which:

FIG. 1 is a side elevational view of a lifting device in accordance with an embodiment of the invention;

FIG. 2 is the same view as FIG. 1 with a portion of the housing removed to reveal internal details; and

FIG. 3 is a sectional view taken along the lines A-B in FIG. 2.

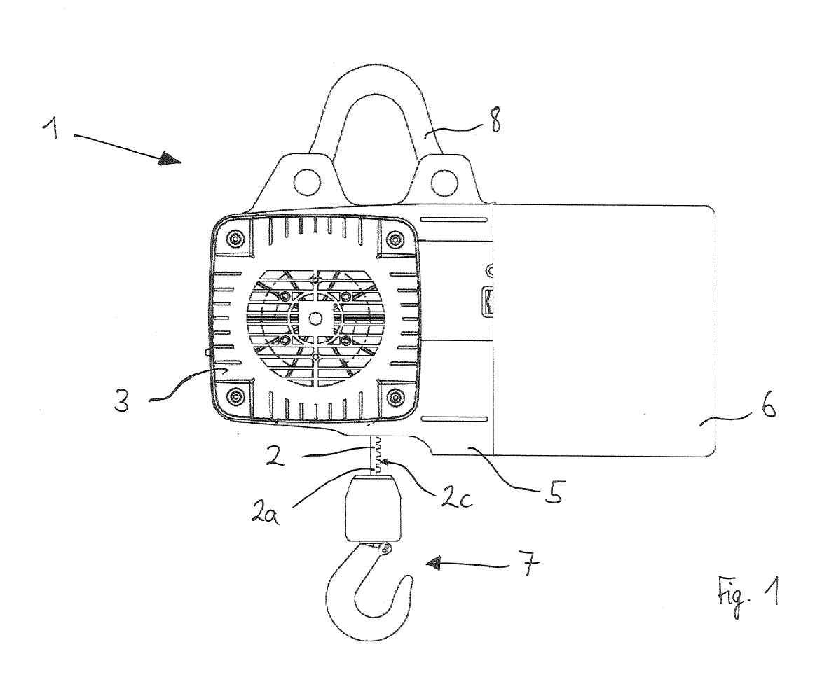

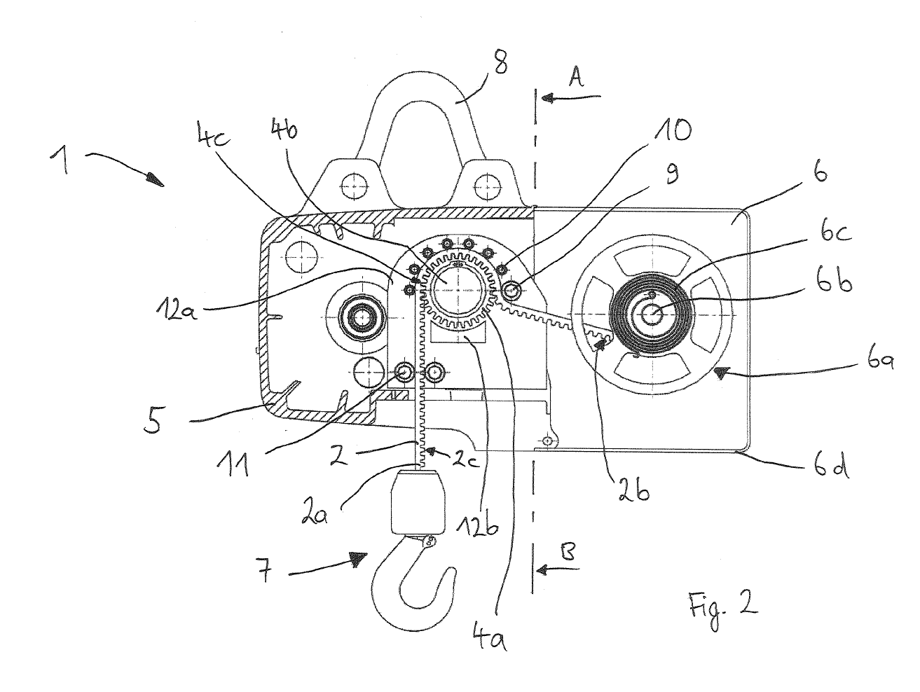

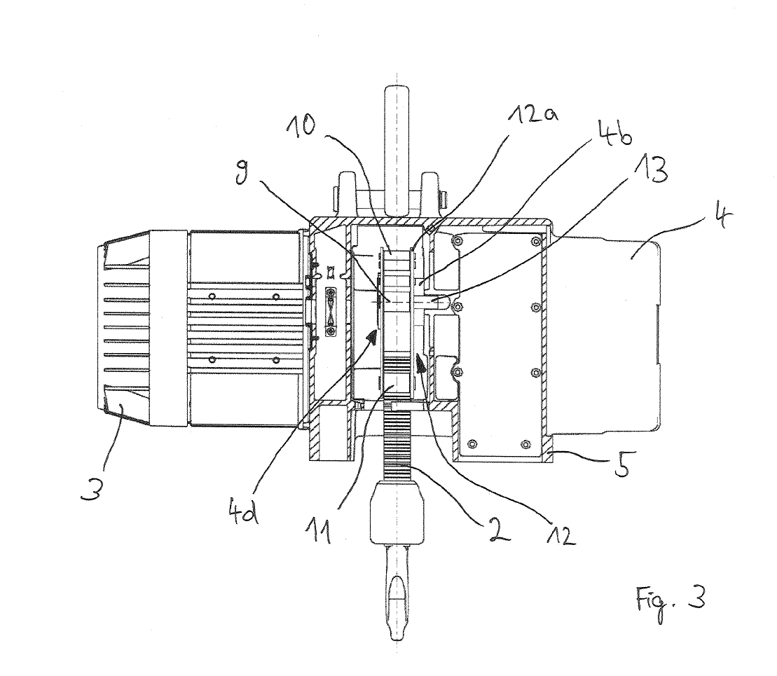

FIG. 1 shows a lifting device, or hoist, 1 having a toothed belt 2 having belt teeth 2c. The lifting device 1 is driven by a motor 3, preferably an electric motor. The drive power applied by the motor 3 is positively transferred to the toothed belt 2 via a gear system 4 shown in FIG. 3 and an output wheel 4a shown in FIG. 2. The motor 3 is flange-mounted to a housing 5 whose installation space is formed in an H-shaped manner in the longitudinal cross-section, not illustrated, which means that the installation space is separated into two installation space halves by a supporting wall. The installation space halves are each open on the sides facing away from the wall as best seen in FIG. 3. The gear system 4 is accommodated in one installation space half and the output wheel 4a is accommodated in the other installation space half. The installation space halves can be closed by corresponding covers.

The toothed belt 2 is stored by a belt store 6 (see FIG. 2), which is not illustrated in detail and is fastened on the side to the housing 5, and is released or accommodated depending upon the direction of rotation of the motor 3 or of the output wheel 4a. The lifting device 1 is formed as a single cable which means that the toothed belt 2 comprises a first freely suspended end 2a, on which a load-connecting device 7 is fastened. The lifting device 1 can be suspended on a supporting element, not shown, by means of a suspension element 8 fastened to the upper side of the lifting device 1, in particular the housing 5 thereof.

FIG. 2 shows a partially broken-away view of the lifting device 1 of FIG. 1, in particular a detailed representation of the guidance of the toothed belt 2 in the lifting device 1. The toothed belt 2 is fastened at its second end 2b to a storage roller 6a which is rotatably mounted on a shaft 6b within the belt store 6. The shaft 6b is mounted in a container-like storage housing 6d. The storage roller 6a is connected to the shaft 6b via a torsion spring 6c in the manner that, starting from the toothed belt 2 which is wound on the storage roller 6a, unwinding of the toothed belt 2 tensions the torsion spring 6c and thus in accordance with the principle known from a roller blind winder the toothed belt 2 can be rolled back onto the storage roller 6a via the force resulting from the energy stored in the tensioned torsion spring 6c.

Starting from the storage roller 6a, the toothed belt 2 leaves the belt store 6 or the storage housing 6d thereof in the direction of the housing 5 and is directed from the belt store 6 into the housing 5 by means of a deflecting roller 9, which is rotatably mounted on the housing 5, and is supplied laterally to the output wheel 4a disposed therein. The output wheel 4a is connected in a rotationally-fixed manner to the output shaft 4b, which cooperates with the non-depicted gear system 4 (see FIG. 3), and is rotatably mounted on the housing 5. The radially rotating surface of the output wheel 4a has a profile which is formed complementarily to the surface contour of the toothed belt 2 and preferably in the form of wheel teeth 4c. Furthermore, the guidance of the toothed belt 2 on the output wheel 4a is supported by a total of seven guide rollers 10 in the illustrated embodiment. The guide rollers 10 are positioned in the region of the output wheel 4a and are spaced apart from each other distributed approximately over the upper half of the wheel periphery thereof such that in this region the profiled side of the toothed belt 2 supplied between the guide rollers 10 and the output wheel 4a is brought into positive engagement with the wheel teeth 4c of the output wheel 4a. The wrap-around region, in which the positive engagement is produced, extends, in relation to a notional rotation about the rotational axis of the output wheel 4a, over at least 90°, but may be 120° to 180° and in particular 120° to 150°. In order for a uniform guidance or a uniform pressing of the toothed belt 2 on the output wheel 4a to be ensured over the entire wrap-around region, at least two guide rollers 10 are provided over each sub-region of the wrap-around region encompassing 30°. The toothed belt 2 is guided by the guide rollers 10 over the rotating output wheel 4a such that the free first end 2a of the toothed belt 2 leaves the output wheel 4a on the side facing away from the storage roller 6a and is released vertically downwards. The output wheel 4a may be formed as a toothed belt disk.

The release of the toothed belt 2 is supported by a stripping element 12b which is fastened in the housing 5 in the region of the lower half of the output wheel 4a such that the positive connection is interrupted by a splitting wedge effect of the correspondingly formed geometry of the stripping element 12b. Typically, the load suspended on the load-connecting device 7 is sufficient to allow the toothed belt 2 to securely run off from the output wheel 4a. A cartridge wall 12a is connected to the stripping element 12b, the function of which is described in detail in FIG. 3. The released toothed belt 2 is guided out of the housing 5 vertically downwards below the output wheel 4a between idler rollers 11 disposed at the lower edge of the housing 5. The load-connecting device 7 is fastened to the first end 2a of the toothed belt 2. The axes of rotation of the output shaft 4b, the shaft 6b, the deflecting roller 9, the guide rollers 10 and the idler rollers 11 are aligned in parallel with each other in the illustrated embodiment.

FIG. 3 shows a front view of FIG. 2 in the partial section A-B, in which a cartridge 12 having cartridge walls 12a is shown as an advantageous embodiment for the rotatable bearing of the rollers 9 (see FIGS. 2), 10 and 11. Only one roller 10 and 11 is shown in cross-section in each case. The cartridge 12 is designed as a component releasably mounted in a floating manner on the output shaft 4b or the output wheel 4a (see FIG. 2) and includes, in addition to the rollers 9, 10 and 11, the output wheel 4a and the stripping element 12b (see FIG. 2). The cartridge walls 12a have bearing openings by means of which the rollers 9, 10 and 11 are positioned and rotatably mounted between two cartridge walls 12a. When the cartridge 12 is not mounted into the lifting device 1, the stripping element 12b fastened to at least one of the cartridge walls 12a secures the output wheel 4a—disposed in a non-fastened manner between the stripping element 12b and the guide rollers 10—against vertically falling out from the region of the guide rollers 10 disposed approximately in a semi-circular manner. As a result, the output wheel 4a is pre-positioned approximately concentrically in relation to reception openings for the through-guidance of the output shaft 4b between the cartridge walls 12a.

The cartridge 12 is located within the housing 5 on the output shaft 4b co-operating with the gear system 4, which output shaft is guided through the reception opening at least of the cartridge wall 12a facing the gear system 4, wherein the connection between the output shaft 4b and the output wheel 4a is preferably a positive connection. The cartridge 12 is secured axially on the output shaft 4b via the output wheel 4a, e.g., by a securing ring 4d located on the free end of the output shaft 4b, i.e., the end facing away from the gear system 4. In addition, the cartridge 12 is prevented from rotating via at least one pin 13, which is disposed to protrude laterally on the cartridge 12 and is supported in cut-outs provided in the housing 5. The housing 5 thus acts as an abutment in particular for the guide rollers 10 and as a result is not entrained by the rotating output wheel 4a. The toothed belt 2 is guided through the cartridge 12 by the rollers 9, 10 and 11 in the manner depicted in FIG. 2, wherein the toothed belt 2 is either already inserted into the cartridge 12 in a positive-locking manner with the output shaft 4a during assembly and then the second end 2b is fastened to the storage roller 6a, or the second end 2b of the toothed belt 2 is initially fastened to the storage roller 6a and then the freely hanging first end 2a is threaded into the assembled cartridge 12 and is then correspondingly guided through the cartridge 12.

Alternative to the single-cable exemplified embodiment illustrated in FIGS. 1 to 3, a multi-cable embodiment may be provided in which a load-connecting device 7 is formed as a lower block in a singly reeved embodiment, wherein the first end 2a of the toothed belt 2 is not suspended freely but is fixedly connected to the housing 5. Furthermore, attachment positions for the belt store 6 are different from those in the illustrated embodiment are also feasible, in particular below the housing 5, comparable to the chain store of conventional chain hoists. It is also possible that the toothed belt 2 is wound by a winding motor, such as with a idle motor or a friction clutch instead of via a torsion spring 6c. It is likewise possible to use the belt store 6 like a conventional chain store for chaotically receiving the toothed belt 2 which means that the toothed belt 2 is not wound but, from the output wheel 4a, is merely pressed into the belt store in an unordered manner. As an alternative to the use of the cartridge 12 for bearing the rollers 9, 10 and 11, a corresponding bearing can be effected directly on the housing 5, i.e., in a form not made up as a removable component.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

1. Lifting device for lifting and lowering loads, comprising:
a toothed belt driven by an output wheel and positively engaged with the output wheel in a wrap-around region;
at least three guide rollers disposed one behind the other as seen in the peripheral direction of the output wheel in the wrap-around region wherein said guide rollers press the toothed belt against the output wheel in the wrap-around region and thus maintain the positive connection between the toothed belt and the output wheel.

2. The lifting device as claimed in claim 1 wherein two adjacent ones of said guide rollers are spaced apart from each other at most over 30° of the wrap-around region as seen in the peripheral direction of the output wheel.

3. The lifting device as claimed in claim 1 wherein the wrap-around region is at least 90°.

4. The lifting device as claimed in claim 1 including another guide roller or an idler roller for guiding the toothed belt to and from the output wheel.

5. The lifting device as claimed in claim 1 including a load connecting device suspended on the toothed belt.

6. The lifting device as claimed in claim 5 wherein the load connecting device is freely suspended.

7. The lifting device as claimed in claim 5 wherein the load connecting device is suspended on a first end of the toothed belt.

8. The lifting device as claimed in claim 5 wherein the load connecting device is formed as a singly reeved lower block.

9. The lifting device as claimed in claim 1 wherein the output wheel is located on an output shaft in a rotationally-fixed manner and the output shaft is drivingly connected to an electric motor via a gear system.

10. The lifting device as claimed in claim 1 including a belt store which stores the toothed belt.

11. The lifting device as claimed in claim 10 wherein the belt store comprises a storage roller that is rotatably mounted on a shaft and to which the toothed belt is connected at its second end, wherein the toothed belt can be wound on the storage roller.

12. The lifting device as claimed in claim 11 wherein the storage roller is connected to the shaft via a torsion spring such that unwinding of the toothed belt starting from a wound toothed belt tensions the torsion spring and the toothed belt can be wound on the storage roller via the force resulting from the energy stored in the tensioned torsion spring.

13. The lifting device as claimed in claim 11 wherein the storage roller is drivingly connected to an electric winding motor.

14. The lifting device as claimed in claim 13 including at least one deflecting roller that guides the toothed belt from the belt store to the output wheel and at least two idler rollers carry the toothed belt from the output wheel, wherein the deflecting roller and the idler rollers are fastened to a housing of the toothed belt pulley.

15. The lifting device as claimed in claim 10 including at least one deflecting roller that guides the toothed belt from the belt store to the output wheel and at least two idler rollers carry the toothed belt from the output wheel, wherein the deflecting roller and the idler rollers are fastened to a housing of the toothed belt pulley.

16. The lifting device as claimed in claim 2 wherein the wrap-around region is at least 90°.

17. The lifting device as claimed in claim 16 including a guide roller or an idler roller for guiding the toothed belt to and from the output wheel.

18. The lifting device as claimed in claim 2 including a load-connecting device suspended on the toothed belt.

19. The lifting device as claimed in claim 18 wherein the load-connecting device is freely suspended.

20. The lifting device as claimed in claim 18 wherein the load-connecting device is suspended on a first end of the toothed belt.

21. The lifting device as claimed in claim 18 wherein the load-connecting device is formed as a singly reeved lower block.

22. The lifting device as claimed in claim 1 including at least five guide rollers disposed one behind the other as seen in the peripheral direction of the output wheel in the wrap-around region.

23. The lifting device as claimed in claim 22 including at least seven guide rollers disposed one behind the other as seen in the peripheral direction of the output wheel in the wrap-around region.

24. The lifting device as claimed in claim 1 wherein the wrap-around region is approximately 120° to 150°.

25. The lifting device as claimed in claim 1 wherein the wrap-around region is approximately 120° to 180°.
